(19) United States
(12) Patent Application Publication
(10) Pub. No.: US 2016/0119200 A1
(43) Pub. Date: Apr. 28, 2016

(54) SYSTEMS AND METHODS FOR PROVIDING USER ANALYTICS

(71) Applicant: rocket-fueled, Inc., Decatur, AL (US)

(72) Inventors: David A. Fuller, Decatur, AL (US); Joshua S. Hogue, Harvest, AL (US)

(21) Appl. No.: 14/921,744

(22) Filed: Oct. 23, 2015

Related U.S. Application Data
(60) Provisional application No. 62/067,846, filed on Oct. 23, 2014.

(51) Int. Cl. H04L 12/26

(52) U.S. Cl. CPC H04L 43/04

(57) ABSTRACT

Systems and methods are provided for capturing user analytics for user experiences on, for example, a website, mobile application, and/or at an offline location, venue and/or event without requiring a programmer to provide specialized code in each instance. When a user event occurs, such as a click or other selection of an object and/or user action, a user analytics system captures and stores information about the event. The captured information is such that an administrator or other user is capable of identifying the object and associated analytics by viewing the captured information and/or graphical representations thereof. In addition, a user may define a model flow for comparison to actual user flows by simply navigating through a website, mobile application, and/or at an offline location, venue and/or event in a manner that the user believes is similar to how other users will navigate through the website, mobile application, and/or at an offline location, venue and/or event. The system identifies the sequence of objects selected by the user to define the model flow.

### CROSS-REFERENCE TO RELATED APPLICATIONS

This application claims the benefit of U.S. Provisional Application No. 62/067,846, entitled “Systems and Methods for Providing User Analytics,” and filed Oct. 23, 2014, which application is hereby incorporated by reference in its entirety.

### RELATED ART

A user analytics system records, discovers, evaluates, prioritizes and reports patterns of user behavior. Such systems may be used to track user activity online or offline. Prime examples are user analytics systems which track website usage and provide various data and statistics about how users navigate to, from and/or through a website. In this regard, a user analytics system often employs specialized code, such as a Java script, that executes on a webserver and tracks which objects (e.g., images, videos, or text) are clicked or otherwise selected by users and how a user scrolls through the website. The data provided by a user analytics system can be used to provide analysis of user behavior when using the website. As an example, a user analytics system may track and report the percentage or number of users that clicked or otherwise selected a certain object or a certain sequence of objects.

In some cases, a website owner, operator, administrator, data analyst, software developer or other person defines a model flow indicating how he or she believes users will navigate through a website (such as a sequence of objects that he or she believes will be clicked or otherwise selected by users). The user analytics system compares the actual user flows to the model flow to determine the extent to which the users followed the model flow. As an example, the user analytics system might indicate that 50% of the users clicked through the first two objects of the model flow but only 15% of the users clicked the third object of the model flow. Such analytics may be useful in identifying problem areas in the website and in helping design and/or configure the website to better achieve the objectives of its owner/operators.

Current user analytics systems often require a software developer who must uniquely program the user analytics system for each different website. In this regard, the software developer is required to identify the different objects to be tracked so that the user events (e.g., clicks, taps or other user input) tracked by the tool can be referenced to the correct objects. That is, within the code, the software developer defines a referencing system that is used by the code to indicate which object is clicked, tapped or otherwise selected and/or engaged during a user event. Such programming is burdensome and costly.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a communication system.

FIG. 2 is a block diagram illustrating an exemplary webpage of a website hosted by a webserver, such as is depicted by FIG. 1.

FIG. 3 is a block diagram illustrating another exemplary webpage of a website hosted by a webserver, such as is depicted by FIG. 1.

FIG. 4 is a block diagram illustrating an exemplary embodiment of a user analytics server, such as is depicted by FIG. 1.

FIG. 5 depicts an exemplary display of analytics by a user analytics system.

FIG. 6 shows an exemplary embodiment of a process for defining a model flow.

### DETAILED DESCRIPTION

The present disclosure generally pertains to systems and methods for providing user analytics for user experiences on any local area network (LAN), a wide area network (WAN), any other type of communication network, website, mobile web or native language mobile application or at any offline venue, event or location without requiring a programmer to provide specialized code in each instance. In this regard, when a user event occurs, such as a click or other selection of an object and/or user action, a user analytics system captures and stores information about the event. The captured information is such that an administrator or other user is capable of identifying the object by viewing the captured information and/or graphical representations thereof. As an example, if the object is a video or an image, the filename of the video or image may be captured. Alternatively, all or a portion of the video or the image data may be captured. Later, when the analytics is displayed to a user, the analytics may be displayed along with the captured information, such as the filename, image, or video or audio (e.g., a clip of the video or audio may be displayed to the user next to the analytics information indicating how many users clicked or otherwise selected such object). For a textual object, at least a portion of the text from the object may be captured. Later, when the user is viewing analytic information indicating how often the object has been clicked or otherwise selected and/or engaged, such analytic information may be displayed along with the captured text so that the administrator is aware of which object from the source is associated with the analytic information being displayed.

Since the information that identifies a tracked object is captured, for example, from a webpage (e.g., html document or files that are displayed on the webpage), there is no need for a software developer to provide a reference for each object that is to be tracked. That is, the user viewing a score for a given object is capable of discerning which object is associated with the displayed score by viewing the information captured for the object by the user analytics system.

Using the user analytics system, a user (e.g., a website administrator) may define a model flow for comparison to the analytic information without having to program specialized code for the website. In this regard, the user simply navigates through the website in a manner that he or she believes users will navigate (e.g., selecting a sequence of objects). Using the same techniques described above, the user analytics system identifies the sequence of objects clicked, tapped or otherwise selected and/or engaged by the administrator, thereby defining a model flow. Such model flow may be compared to the actual user flows to determine the extent to which users track the model flow. On a touchscreen device this maybe accomplished in real time with simple swipes and/or taps of the administrator's finger. Other input methods may also be utilized.

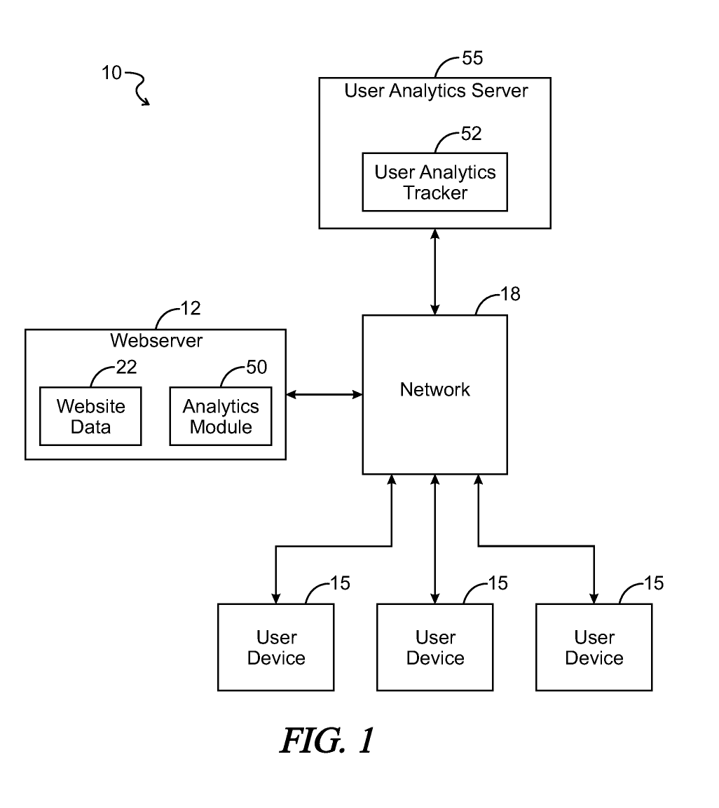

FIG. 1 depicts an exemplary embodiment of a communication system 10. As shown by FIG. 1, the system 10 includes a webserver 12 for hosting a website that can be accessed by any of a plurality of user devices 15. In this regard, each user device 15 is communicatively coupled to a network 18 and is capable of communicating with the webserver 12 via the network 18. As an example, a user device 15 may be implemented as desktop or laptop computer, a mobile device, such as a cellular telephone (e.g., smartphone), or any other device capable of communicating with the webserver 12 via the network 18 and/or displaying information received from the network 18 or other component of the system 10. In addition, the network 18 may include a local area network (LAN), wide area network (WAN), or any other type of communication network, including, but not limited to, those linked to or otherwise associated an offline venue, event or location. In one exemplary embodiment, the network 18 may include numerous devices over different protocols, such as landline computers and/or tablets, smartphones, cellular connected mobile devices, Bluetooth input devices, still and/or video cameras, attachable, wearable, implantable or non-invasive devices as well as other wireless and/or wired input and/or communications devices. In another exemplary embodiment, the network 18 can be the Internet and transmission control protocol/Internet protocol (TCP/IP) can be used to communicate through the network 18, but other types of networks 18 and protocols are possible in other embodiments.

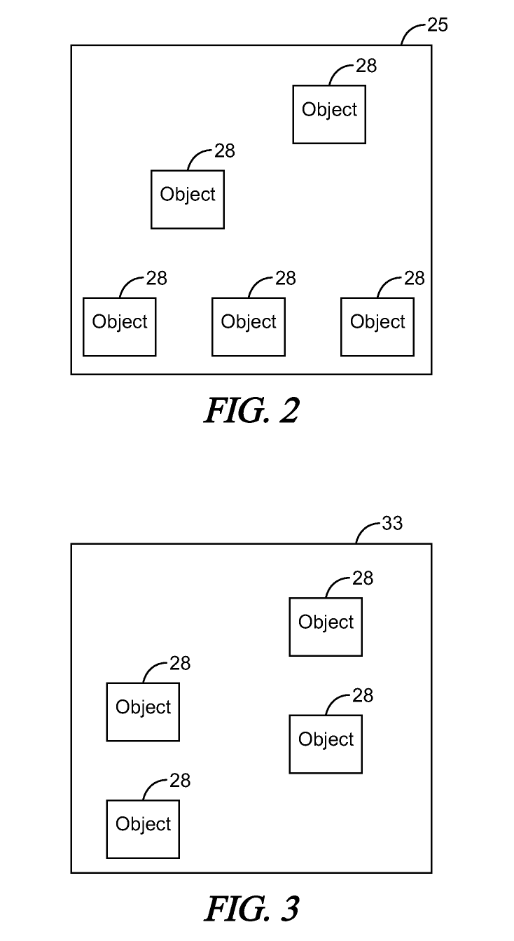

As shown by FIG. 1, the webserver 12 stores website data 22 for defining a website that can be accessed by any of the user devices 15. As an example, the website data 22 may define a plurality of webpages that can be retrieved and rendered via a user device 15. FIG. 2 depicts an exemplary webpage 25 that may be defined by the website data 22 and displayed to a user by a user device 15. As shown by FIG. 2, the webpage 25 may have a plurality of objects 28, such as images, videos, text, or selectable icons for triggering various user events. A user may provide inputs to user device 15 displaying the webpage 25 in order to select one or more of the objects 28. As an example, an object 28 may be a thumbnail image that is expanded to a larger image when selected by user input. An object 28 may also be associated with video or audio that is played when selected by a user input, or an object 28 may define text readable by a user. In one embodiment, when an object 28 is clicked or otherwise selected by a user input, a second webpage 33 (FIG. 3) having a plurality of objects 28 may be displayed to the user. The plurality of objects 28 displayed on the second webpage 33 can have one or more objects 28 that are different from objects 28 displayed on webpage 25. Moreover, a user may provide inputs for navigating through the website selecting various objects 28 of interest to the user, and some of the objects 28 when selected may direct the user to a different webpage. As will be described in more detail below, a user analytics system records this navigation in whatever form to provide a timeline and/or to place the selection and/or engagement of objects 28 in context as well as to discover, evaluate and report relationships and patterns.

In this regard, as shown by FIG. 1, the system 10 i a user analytics system that includes at least an analytics module and a user analytics tracker. In one exemplary embodiment, the analytics module 50 resides on the webserver 12 and communicates with the user analytics tracker 52 that is hosted by a server 55, referred to herein as “user analytics server.” As an example, the analytics module 50 may include software (e.g., Java script) that is downloaded to the webserver 12 from the user analytics server 55 or other source. The analytics module 50 may be executed on the webserver 12 and interact with the user analytics tracker 52 on user analytics server 55 for tracking how users navigate through the website hosted by the webserver 12.

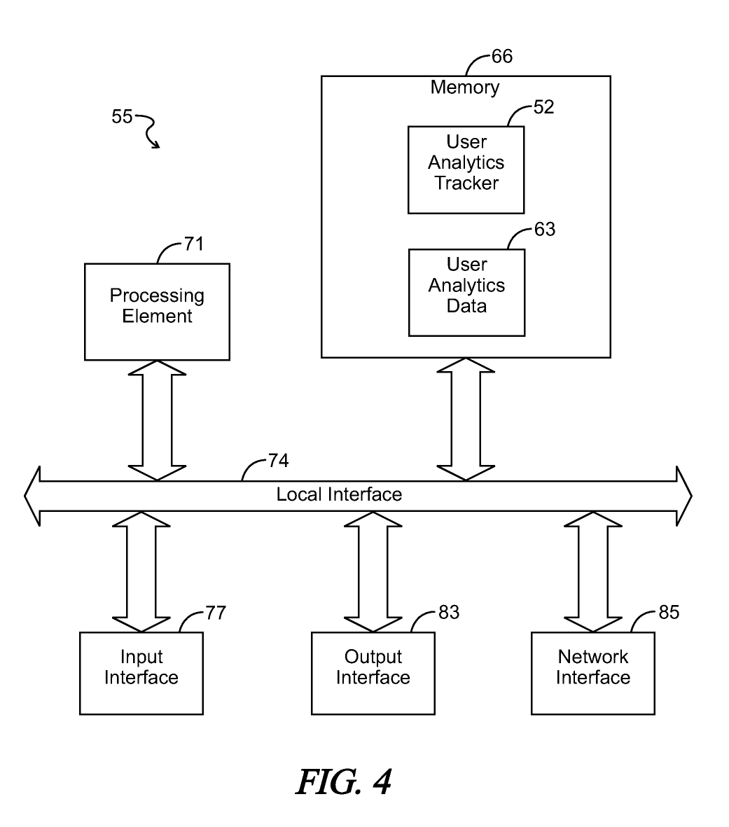

As an example, the analytics module 50 may monitor navigational commands received from the user devices 15 to determine when certain user events occur, such as a selection of a certain object 28. When an event is detected, the analytics module 50 transmits information indicative of the event to the user analytics tracker 52 via the network 18, and the user analytics tracker 52 stores information, referred to herein as user analytics data 63 (see FIG. 4), indicative of the detected events. Thus, the user analytics data 63 can be analyzed to determine how users navigate through a website or any other form of user experience where data may be captured. As an example, for each object 28, the user analytics data 63 may indicate the number of times that the object was selected by users. In this regard, the information and statistics provided by the user analytics tracker 52 may be similar to the information and statistics provided by conventional user analytics systems, except as will be otherwise described hereafter.

FIG. 4 depicts an exemplary embodiment of the user analytics server 55. As shown by FIG. 4, the server 55 includes the user analytics tracker 52, which can be implemented in software, hardware, firmware or any combination thereof. In the exemplary server 55 illustrated by FIG. 4, the user analytics tracker 52 is implemented in software and stored in memory 66. Note that, as described above, the analytics module 50 may also be implemented in software, but other configurations of the user analytics tracker 52 and the analytics module 50 are possible in other embodiments.

The user analytics tracker 52 or the analytics module 50, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary server 55 depicted by FIG. 4 includes at least one conventional processing element 71, such as a digital signal processor (DSP) or a central processing unit (CPU), that communicates to and drives the other elements within the server 55 via a local interface 74, which can include at least one bus. An input interface 77, for example, a keyboard or a mouse, can be used to input data from a user of the server 55, and an output interface 83, for example, a printer, monitor, liquid crystal display (LCD), or other display apparatus, can be used to output data to the user. Further, a network interface 85, such as at least one modem, may be used to exchange data with the network 18 (FIG. 1).

When an event (e.g., a user click, tap or other type of user selection and/or engagement of an object 28) occurs, the analytics module 50 is configured to send to the user analytics tracker 52 information, referred to herein as “object identification information,” that can be used by a user to identify the selected object 28 when such object identification information is viewed by the user. In one exemplary embodiment, the object identification information includes a portion of the object 28 that is visible to a user when the object 28 is displayed in the object's webpage. For example, if the object 28 is an image, such as a picture, the object identification information may be the image data defining the image or at least a portion of the image that is displayed in the object's webpage, mobile application screen or other data source. If the object 28 is a video, the object identification information may be the image data defining the video or at least a portion of the video (e.g., one or more frames of the video) that is displayed in the object's webpage, mobile application screen or other data source. If the object 28 is textual, the object identification information may be the text or at least a portion of the text that is displayed in the object's webpage. or mobile application screen or other data source. In other embodiments, the object identification information may be other types of information that is native to the object 28, such as the filename of the object 28. In the context of this document, information is “native” to the object 28 when it is captured from the object's data source and, specifically is not generated or created by the analytics module 50. That is, information is native to the object 28 when it is part of the object 28 or is associated with the object 28 in the absence of the analytics module 50 and the user analytics tracker 52.

For each object 28 to be tracked, the user analytics tracker 52 is configured to correlate, in the user analytics data 63, the object identification information for a given object with at least one parameter, referred to hereafter as “usage parameter,” indicative of an extent to which such object 28 is selected or otherwise used by users. As an example, the usage parameter may be a value indicating the number of times that the object 28 is selected by a user navigating through the website hosted by the webserver 12. Such value may be used to calculate and report various statistics about the usage of the website. As an example, the number may be used to calculate a percentage of users who selected the associated object 28, or the number may be used to calculate another type of metric.

Note that there are various techniques that may be used to update the usage parameters as users navigate through the website. For example, when a particular object 28 is selected and the object identification information is transmitted to the user analytics tracker 52, the user analytics tracker 52 may be configured to compare such object identification information to the object identification information stored in the user analytics data 63. If there is a sufficient correlation between the received object identification information and a stored set of object identification information (e.g., the received object identification information matches a stored set of object identification information), then the user analytics tracker 52 may determine that the two sets of object identification information are associated with the same object 28. In such case, the user analytics tracker 52 may increment or otherwise update the usage parameter correlated with the stored set of object identification information thereby indicating that another selection of the associated object 28 has been detected. In other embodiments, other techniques for updating the usage parameters in response user events are possible.

In any event, the metrics calculated by the user analytics tracker 52 based on the usage parameters may be displayed by the output interface 83 of the user analytics server 55 or otherwise. As an example, a user may communicate with the user analytics server 55 using a user device 15 or other type of device and then use the device 15 to display the metrics calculated by the user analytics tracker 52.

When a metric is displayed, the object identification information associated with the same object 28 is displayed such that the object identification information is correlated with the metric. As an example, the object identification information may be displayed next to, in close proximity to, or aligned with the metric such that a user readily correlates the object identification information and the metric being displayed.

Since the object identification information is native to the object 28 (e.g., a portion of the displayed object 28), a user should be able to discern which object is correlated with the object identification information and, hence, the metric. As an example, when the object identification information is a portion of the displayed object 28, a user can compare the object identification information to the displayed object 28 in order to ascertain the correlation between the object identification information and the object 28. That is, the object identification information may look the same as at least a portion of the object 28. As an example, if the object 28 is a picture or image, the object identification information displayed with the metric may be at least a portion of the picture or image. If the object 28 is a video or audio, the object identification information displayed with the metric may be one or more frames of the video or seconds of the audio that are displayed next to the metric.

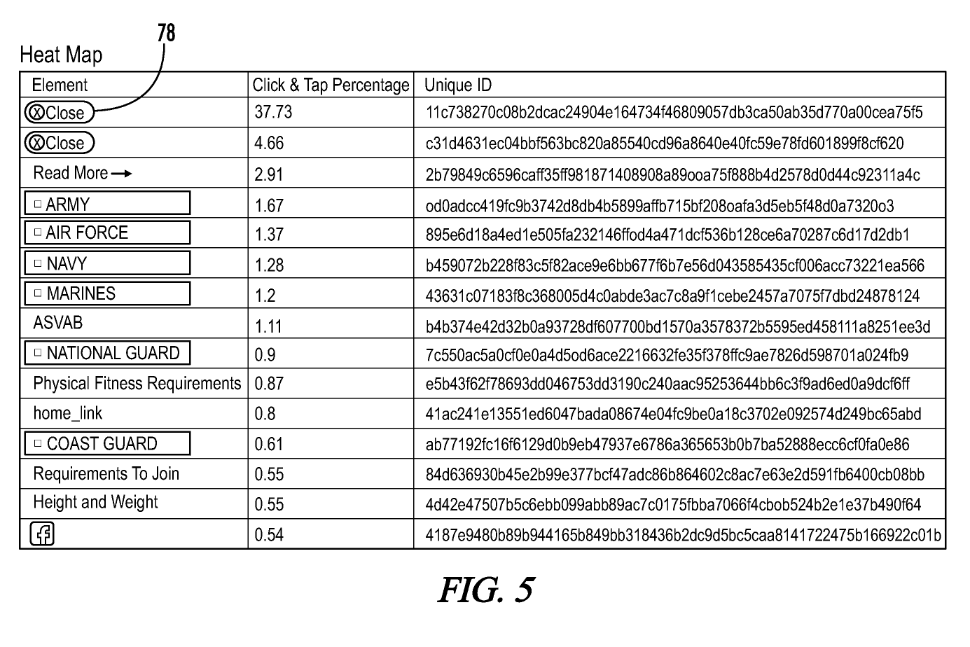

As an example, refer to FIG. 5, which shows an exemplary display or heatmap rendered by the user analytics tracker 52 for indicating the analytics of a webpage. Assume that the webpage includes an object 28, referred to as “close object,” that has the appearance of the object 78 in FIG. 5. When close object is selected by a user, the webpage is closed. The object identification information captured by the user analytics system for such close object defines an image of the close object which is rendered on the analytics page or heatmap shown by FIG. 5. Further, in FIG. 5, the close object is correlated with a value (i.e., 37.73) indicating that 37.73 percent of the users who visited the webpage also clicked or otherwise selected the close object.

Note that the user analytics tracker 52 may assign identifiers, referred to as “unique ID” in FIG. 5, in order to facilitate processing of the objects 28 and associated analytics data. Such assignment may be arbitrary as the object identification information is captured or according to an algorithm. However, it is unnecessary for the unique IDs to be assigned to their respective objects prior to capture.

Also assume that the foregoing webpage includes a selectable textual phrase “Physical Fitness Requirements”. When the textual phrase is selected by a user, information about physical fitness requirements are displayed to the user. The object identification information captured by the user analytics system for such textual phrase is the phrase itself, which is rendered on the analytics page shown by FIG. 5. Further, the textual phrase is correlated with a value (i.e., 0.87) indicating that 0.87 percent of the users who visited the webpage also clicked or otherwise selected the textual phrase. While FIG. 5 shows one embodiment of a graphical display format for the analytics data, other types and formats of graphical displays can be generated by the analytics tracker 52 to provide the analytics data to a user.

Accordingly, when using the user analytics tracker 52 or the analytics module 50, it is unnecessary for a software developer to define a reference, such as a unique name, number or element identification (ID), for referencing the object 28. That is, a user is capable of determining which object is correlated with a displayed metric without having to display a reference name, number or element ID created by the software developer. Thus, it is unnecessary for the analytics module 50 or the user analytics tracker 52 to be specially programmed or otherwise configured depending on the data source (e.g., website or mobile application). In this regard, the analytics module 50 and the user analytics tracker 52 may be used with any data source without having to reprogram or otherwise reconfigure the analytics module 50 or the user analytics tracker 52.

In one exemplary embodiment, the user analytics tracker 52 is configured to compare a model flow of user events to actual user flows in order to determine and report an extent to which users follow the model flow. As an example, a website or other data source administrator may believe that users are likely to select a certain sequence of objects 28 and, thus, define a model flow indicative of such sequence. The user analytics tracker 52 then determines the extent to which users actually follow the model flow by selecting the objects 28 in the anticipated sequence.

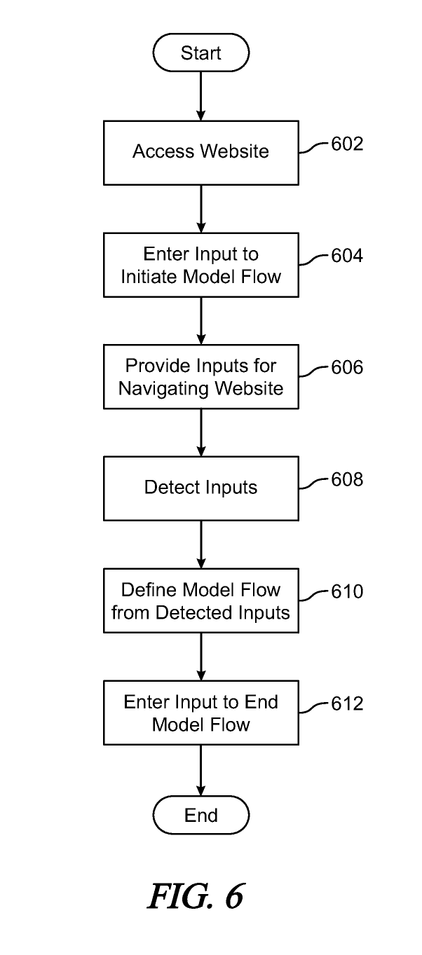

In order to facilitate creation of the model flow to which actual user flows are to be compared, the user analytics tracker 52 operates in a mode, referred to herein as “model initiation mode,” that allows a user to easily define the model flow. FIG. 6 shows an exemplary embodiment for defining a model flow. The process begins with a user accessing the website or other data source hosted by the webserver 12 using a user device 15 (step 602). The user then provides an input, such as a certain keystroke or sequence of keystrokes; or, taps, if using a touchscreen device, for indicating a desire to define a model flow (step 604). Such input is communicated to the webserver 12, and the analytics module 12 interprets the input as a command for defining a model flow. The module 12 reports such command to the user analytics tracker 52, which is responsive to the command for operating in the model initiation mode for defining a model flow. Thereafter, the user provides inputs for navigating through the website or other data source, thereby selecting objects 28 in a desired sequence (step 606).

While in the model initiation mode, the analytics module 50 continues to detect and report to the user analytics tracker 52 user events, such as selections of objects 28, as described above for the normal mode of operation (step 608). However, in the model initiation mode, the user analytics tracker 52 uses the events detected by the analytics module 50 to define a model flow (step 610). As an example, the user analytics tracker 52 may store the sets object identification information in the sequence received from the analytics module 50 as a model flow to be compared to actual user flows later.

Once the user has completed the model flow in the model initiation mode, the user may provide an input, such as a certain keystroke or sequence of keystrokes; or, taps, if using a touchscreen device, for indicating that model flow is complete (step 612). Such input is communicated to the webserver 12, and the analytics module 12 interprets the input as a command for ending the model initiation mode. The module 12 reports such command to the user analytics tracker 52, which is responsive to the command for transitioning from the model initiation mode to the normal mode. That is, the user analytics tracker 52 begins tracking the events reported to it by the analytics module 50, as described above. If the user desires to define another model flow, the user may repeat the process described above.

After a model flow is defined and the user analytics tracker 52 is transitioned back to the normal mode of operation, the user analytics tracker 52 compares the events detected by the analytics module 50 to the model flow in order to determine a usage parameter indicating the extent to which the actual user flows follow the model flow. For example, the user analytics tracker 52 may compare sets of object identification information received from the analytics module 50 during normal operation to the model flow defined during the model initiation mode. Based on this comparison, the user analytics tracker 52 may track the extent to which the sets of object identification information match the model flow. In other embodiments, other techniques for comparing the actual flows to the model flow and for assessing the extent to which the actual flows match the model flow are possible.

In the embodiments described above, the analytics module 50 is shown as being executed on the webserver 12, and the user analytics tracker 52 is shown as being executed on a server 55 that is remote from the webserver 12. In other embodiments, other configurations are possible. As an example, it is possible for the user analytics tracker 52 to be executed or reside on the webserver 12 and for the analytics module 50 to be executed or reside on the user devices 15. Various other changes and modifications would be apparent to a person of ordinary skill upon reading this disclosure.

In addition, the webserver 12 is also described above as hosting a website defined by website data 22. Note that the website data 22 may include a Hyper Text Markup Language (HTML) document and other types of data typically used to provide webpages. The website may be designed for use on user devices 15 of various sizes, such as desktop or laptop computers, smartphones, Bluetooth input devices, still and/or video cameras, attachable, wearable, implantable or non-invasive devices as well as other wireless and/or wired input and/or communications devices. In some cases, a website or other data source may be specifically designed for use on small-scale mobile devices, such, but not limited to, as smartphones. Software for providing such a website is sometimes referred to as a “mobile web application.” In addition, it is possible for the webserver 12 to include a native language application that is specifically designed for use with user devices 15 having a certain operating system. For example, the application may be specifically tailored for iOS, Android, or Windows Mobile devices. The user analytics tracker 52 may be configured for use with any of these types of user data sources as well as others. Moreover, for the various types of user data sources that may be provided by the webserver 12, the general configuration and operation of the user analytics tracker 52 can be the same as described above.

The user analytics system can be implemented on a website, mobile web application, and native language mobile application. A website may be any collection of pages viewable by a web browser application being executed on desktop and mobile devices. The website code is modified, with a single line added, to activate the user analytics system for that specific website. From that point forward, the events that take place by users on that website can be tracked in the user analytics system. A mobile web application may be a mobile-enhanced website or mobile stand-alone application that executes on a local web-based application on the device. The process for implementing the user analytics system for a mobile web application is the same as for a normal website. In one possible embodiment, the analytics module 50 and user analytics tracker 52, described above may be configured to track and exchange data on the percentage of users employing specific operating systems, mobile devices, browsers and/or other data on user devices 15 and/or the software related thereto. Analytics module 50 may be configured to visualize and/or display the data to website and/or application administrators as well as any other authorized user in a manner similar to that already described.

A native language mobile application implements the user analytics system differently due to the distinctly different architecture of these applications. These applications use a web-based application programming interface to talk directly to the analytics system server. The interface includes support for tracking navigation across various screens within a mobile application. The interface supports sending event information to track various types of events that include screen loading, screen leaving (to another screen), tap gestures for elements on the screen, and scroll gestures on the screen. Additional parameters may be provided when sending this event data to the user analytics server 55, including a unique identifier for the element of interest (when tapped on), the positional coordinates on the screen (in pixels) where an event occurred, and the specific device and operating system details of the user. Additionally, the user analytics system will automatically maintain the history and thread of events associated with that user's session of the app and track times of the events internally.

Although the figures herein may show a specific order of method steps, the order of the steps may differ from what is depicted. Also, two or more steps may be performed concurrently or with partial concurrence. Variations in step performance can depend on the software and hardware systems chosen and on designer choice. All such variations are within the scope of the application. Software implementations could be accomplished with standard programming techniques, with rule based logic and other logic to accomplish the various connection steps, processing steps, comparison steps and decision steps.

It should be understood that the identified embodiments are offered by way of example only. Other substitutions, modifications, changes and omissions may be made in the design, operating conditions and arrangement of the embodiments without departing from the scope of the present application. Accordingly, the present application is not limited to a particular embodiment, but extends to various modifications that nevertheless fall within the scope of the application. It should also be understood that the phraseology and terminology employed herein is for the purpose of description only and should not be regarded as limiting.

What is claimed is:

1. A computer implemented method of providing user analytics for user experiences, the method comprising:
displaying a plurality of objects on a user device;
capturing information about a user event with an analytics module in response to a selection of a displayed object by a first user;
transmitting, by the analytics module, the captured information to an analytics tracker to store the captured information on the selected object as analytics data; and
providing the analytics data on the plurality of objects to a second user, wherein the provided analytics data includes at least a portion of the captured information associated with each object to permit the second user to identify the object from the captured information.

2. The method of claim 1, wherein the step of capturing information includes obtaining identifying information about the selected object, the identifying information includes a portion of the selected object visible to the first user when the selected object is displayed on the user device.

3. The method of claim 2, wherein the step of obtaining identifying information about the selected object includes obtaining at least one of a filename associated with the selected object or at least a portion of data associated with the selected object.

4. The method of claim 3, wherein the at least a portion of data associated with the selected object is one of video data, image data, audio data or text.

5. The method of claim 1, further comprising correlating the captured information of the displayed object to at least one parameter in the analytics data.

6. The method of claim 5, further comprising:
repeating the steps of capturing information and transmitting the captured information for a second object of the plurality of objects selected by the first user;
comparing the captured information associated with the selection of the second object to the captured information stored in the analytic data; and
updating the at least one parameter associated with the displayed object in response to the comparison indicating the captured information associated with the selection of the second object matches the captured information of the displayed object.

7. The method of claim 6, wherein the step of providing the analytics data includes displaying the captured information for the displayed object next to the at least one parameter for the displayed object.

8. The method of claim 1, further comprising assigning, by the analytics tracker, a unique identifier to each object of the plurality of objects.

9. The method of claim 8, wherein the step of assigning a unique identifier occurs subsequent to the steps of capturing information and transmitting the captured information.

10. A user analytics system comprising:
a first server, the first server comprising an analytics tracker configured to generate analytical data about a website;
a second server connected to the first server by a network, the second server comprising:
an analytics module configured to enable the second server to provide information to the first server to generate the analytical data; and
website data configured to define one or more webpages of a website, the one or more webpages of the website having a plurality of objects;
at least one user device connected to the first server and the second server by the network, the at least one user device configured to communicate with the second server and display the one or more webpages of the website stored on the second server;
the analytics module configured to capture information about a user event in response to a selection of an object in a webpage displayed on the user device by a user and provide the captured information to the analytics tracker; and
the analytics tracker configured to store the captured information from the analytics module as analytical data, the analytical data including at least a portion of the captured information associated with each object to permit the object to be identified from the captured information.

11. The system of claim 10, wherein the captured information includes identifying information about the selected object, the identifying information includes a portion of the selected object visible to the user when the selected object is displayed on the user device.

12. The system of claim 11, wherein the identifying information about the selected object includes at least one of a filename associated with the selected object or at least a portion of data associated with the selected object.

13. The system of claim 12, wherein the at least a portion of data associated with the selected object is one of video data, image data, audio data or text.

14. The system of claim 10, wherein the analytics tracker is configured to correlate the captured information of the selected object to at least one parameter in the analytical data.

15. The system of claim 14, wherein the analytics tracker is configured to compare the captured information associated with the selection of a second object to the captured information stored in the analytical data and update the at least one parameter of the selected object in response to the comparison indicating the captured information associated with the second object matches the captured information of the selected object in the analytical data.

16. The system of claim 14, wherein the analytics tracker is configured to display the captured information for the selected object next to the at least one parameter for the selected object.

17. The system of claim 10, wherein the analytics tracker is configured to generate a graphical display of the analytical data on the at least one user device to permit a user to review the analytical data.

18. A computer implemented method of defining a model flow for a data source, the method comprising:
accessing a data source hosted by a server with a user device operated by a user;
providing, by the user, inputs into the user device to navigate through the data source;
detecting the user inputs for the data source with an analytics module at the server;
providing the detected inputs to an analytics server; and
defining, with the analytics server, a model flow based on the detected inputs.

19. The method of claim 18, further comprising:
providing, by the user, a first input to initiate the detection of user inputs for the model flow; and
providing, by the user, a second input to end the detection of user inputs for the model flow.

20. The method of claim 18, wherein the step of detecting the user inputs includes obtaining object identifying information associated with each user input, and the step of defining a model flow includes storing, by the analytics server, the obtained object identifying information in a sequence received from the analytics module.
